(19) United States
(12) Patent Application Publication
(10) Pub. No.: US 2011/0032863 A1
(43) Pub. Date: Feb. 10, 2011

(54) Systems and Methods of Supporting Powerline Communications

(75) Inventor: Don Gunasekara, Reston, VA (US)

Correspondence Address: Crowell & Moring LLP, Intellectual Property Group, P.O. Box 14300, Washington, DC, 20044-4300, US

(73) Assignee: Clear Wireless LLC, Kirkland, WA (US)

(21) Appl. No.: 12/534,990

(22) Filed: Aug. 4, 2009

(51) Int. Cl. H04B 7/14; H04L 12/66

(52) U.S. Cl. 370/315; 370/352

(57) ABSTRACT

Systems and methods for powerline communications are provided. A system can include a controller and an extension unit. The controller includes a plurality of transceivers, each of the plurality of transceivers are coupled to a powerline network and a switch coupled to each of the plurality of transceivers. The extension unit includes a transceiver coupled to the powerline network and an interface to a communication unit. The controller is coupled to a broadband wireless network via the powerline network and the switch of the controller switches communications between the extension unit and the broadband wireless network..

### BACKGROUND OF THE INVENTION

There are a variety of different transmission interfaces for communications, including wireless and wired communications. Wired communications are typically employed over wires dedicated solely for supporting communications, e.g., the public switched telephone network (PSTN). Another type of wired communications, commonly referred to as powerline communications, employs electrical powerlines to carry communications. In particular, communication signals are modulated onto the powerline by a transmitter and then demodulated by a receiver.

### SUMMARY OF THE INVENTION

Powerline communications can be particularly useful for businesses. Specifically computer networks, such as local area networks (LANs), and private branch exchanges (i.e., private telephone networks) typically require dedicated wires. If the premises are not wired to support a LAN or PBX then the business will have to pay to have the wiring added. When the business later relocates to different premises the cost of wiring is not recouped. Additionally, once the outlets for the LAN or PBX are installed, the furniture must be arranged around these outlets. Unlike LAN and PBX installations, which require a home-run from the outlet to the switch, powerline communications can be supported using outlets that are coupled serially. Thus, a new outlet can be run off of an existing outlet.

Systems and methods for powerline communications are provided. An exemplary system includes a controller and an extension unit. The controller includes a plurality of transceivers, each of the plurality of transceivers are coupled to a powerline network, and a switch coupled to each of the plurality of transceivers. The extension unit includes a transceiver coupled to the powerline network and an interface to a communication unit. The controller is coupled to a broadband wireless network via the powerline network and the switch of the controller switches communications between the extension unit and the broadband wireless network.

The controller and extension unit can each include a voice compressor. The communication unit can be a public switched network (PSTN) or private branch exchange (PBX) telephone and the extension unit can also include a digital-to-analog/analog-to-digital converter coupled to the extension unit transceiver and a subscriber line interface coupled between the digital-to-analog/analog-to-digital converter and the PSTN or PBX telephone. The communication unit can be a Voice over Internet Protocol (VoIP) telephone or a computer and the extension unit can also include a session initiation protocol (SIP) and media gateway coupled between the extension unit transceiver and the VoIP telephone or computer.

The extension unit can also include a digital-to-analog/analog-to-digital converter coupled to the extension unit transceiver, a subscriber line interface coupled to the digital-to-analog/analog-to-digital converter and a session initiation protocol (SIP) and media gateway coupled to the extension unit transceiver.

The system can include a plurality of unit controllers, each of the plurality of unit controllers are coupled between a respective one of the plurality of transceivers and the switch. The system can also include a broadband transceiver coupled between the controller and the broadband wireless network. The extension unit transceiver and the plurality of transceivers can modulate communications onto a powerline of the powerline network. The communications can be voice communications and/or data communications.

The controller can provide private branch exchange functions, including switching incoming calls to the extension unit, establishing an intercom between the extension unit and another extension unit, placing a call on hold, transferring a call from the extension unit to another extension unit, for varding a call from the extension unit to another extension unit.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary system in accordance with the present invention.

FIG. 2 is a block diagram of an exemplary central control unit in accordance with the present invention.

FIGS. 3A-3C are block diagrams of exemplary extension units in accordance with the present invention.

FIG. 4 is a block diagram of an exemplary filter in accordance with the present invention.

FIG. 5 is a flow diagram of an exemplary method in accordance with the present invention.

### DETAILED DESCRIPTION OF THE PREFERRED EMBODIMENTS

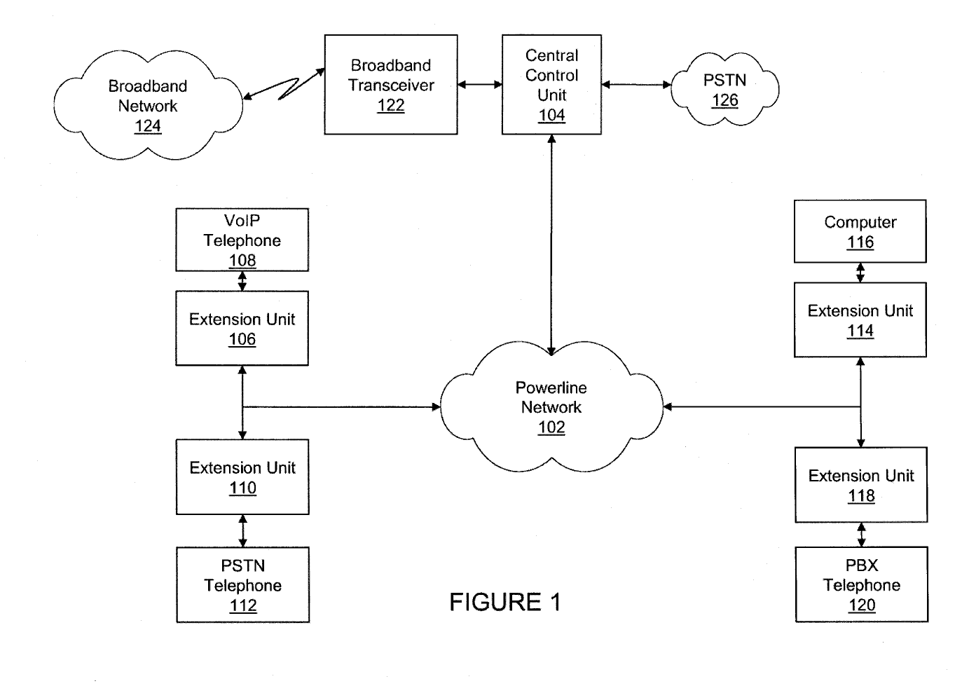

FIG. 1 is a block diagram of an exemplary system in accordance with the present invention. The exemplary system includes a powerline network 102 that couples central control unit 104 to a plurality of extension units 106, 110, 114 and 118. Central control unit 104 is coupled to the PSTN 126, and broadband network 124 via broadband transceiver 122. Broadband network 124 can be, for example, a WiMAX network, LTE network and/or the like. Central control unit 104 allows any type of telephone or computer to exchange communications with another telephone or computer, broadband network and/or PSTN by plugging an extension unit the central control unit and broadband transceiver 122 into an electrical outlet. Additionally, central control unit 104 can provide any type of PBX functionality to extension units 106, 110, 114 and 118 including switching incoming calls to different extension units intercom between extension units, placing calls on hold, transferring calls between extension units, forwarding calls to different extension units, and the like.

Extension unit 106 couples Voice over Internet Protocol (VoIP) phone 108 to central control unit 104, extension unit 110 couples public switched telephone network (PSTN) phone 112 to central control unit 104, extension unit 114 couples computer 116 to central control unit 104 and extension unit 118 couples private branch exchange (PBX) phone 120 to central control unit 104.

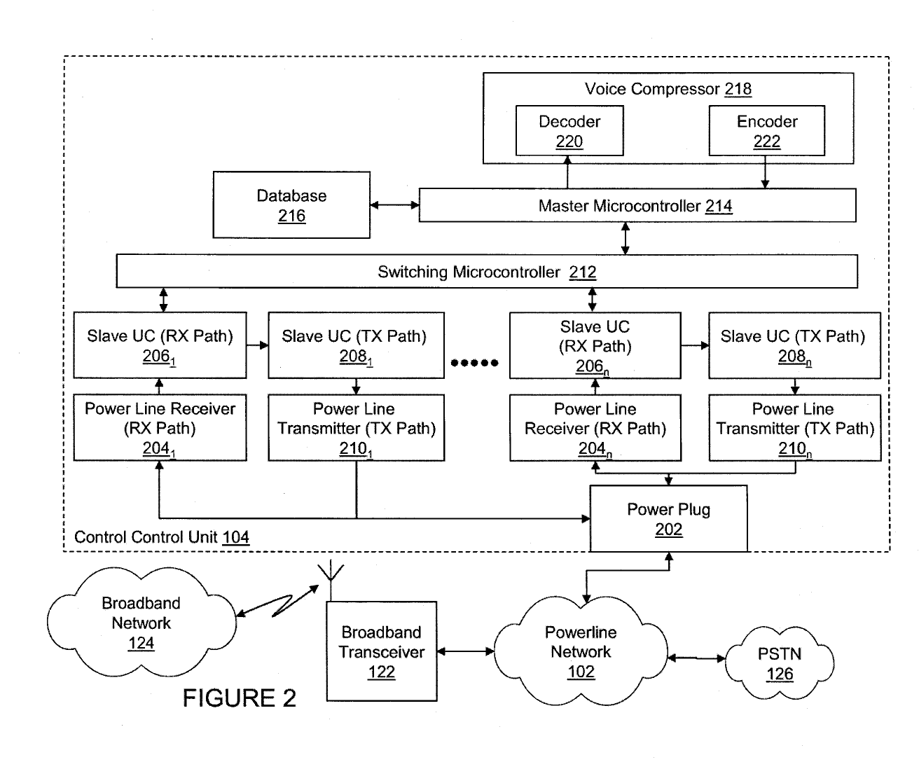

FIG. 2 is a block diagram of an exemplary central control unit in accordance with the present invention. Central control unit 104 includes a power plug 202 that is inserted into an electrical outlet to couple the central control unit to powerline network 102. Power plug 202 is coupled to a plurality of electrical components associated with each extension unit. For each extension unit central control unit 104 includes a powerline receiver 204₁ coupled to power plug 202 and a slave unit controller 206₁. Slave unit controller 206₁ is coupled to slave unit controller 208₁, which in turn is coupled to powerline transmitter 210₁. Slave unit controller 206₁ is coupled to switching microcontroller 212, which in turn is coupled to master microcontroller 214.

Powerline receiver 204, and powerline transmitter 210₁ can be embodied as separate components or as a single transceiver. Regardless, the component will include the ability to support half-duplex frequency shift key (FSK) modulation, and include an integrated powerline driver with programmable voltage and current control. The transceivers can operate at programmable transmission frequencies and/or baud rates. The receiving sensitivity can be adjusted, and the transceiver also provides carrier or preamble detection. Any of the aforementioned functions can be adjusted using a programmable control register.

Master microcontroller 214 is coupled to database 216 and voice compressor 218. Voice compressor 218 includes a decoder 220 and encoder 222. Master microcontroller 214 controls the interfacing with the subscriber line interface cards of the extension units and powerline transceivers. Master microcontroller 214 communicates with switching microcontroller using USART communications. Master microcontroller 214 also manages the PBX functionality, such as any of the PBX functionality discussed above.

Switching microcontroller 212 is responsible for coupling communications between the various extension units, and also between extension units and broadband network 124 and/or PSTN 126. This switching is controlled by master microcontroller 214, using information stored in database 216. Database 216 includes information about the status of each extension unit so that master microcontroller 214 can determine whether the extension unit is busy or available to take an incoming communication. Database 216 can also include other information necessary for supporting PBX functionality.

Voice compressor 218 compresses and decompresses voice for transmission over the powerline network either to other extension units or to broadband network 124 or PSTN 126.

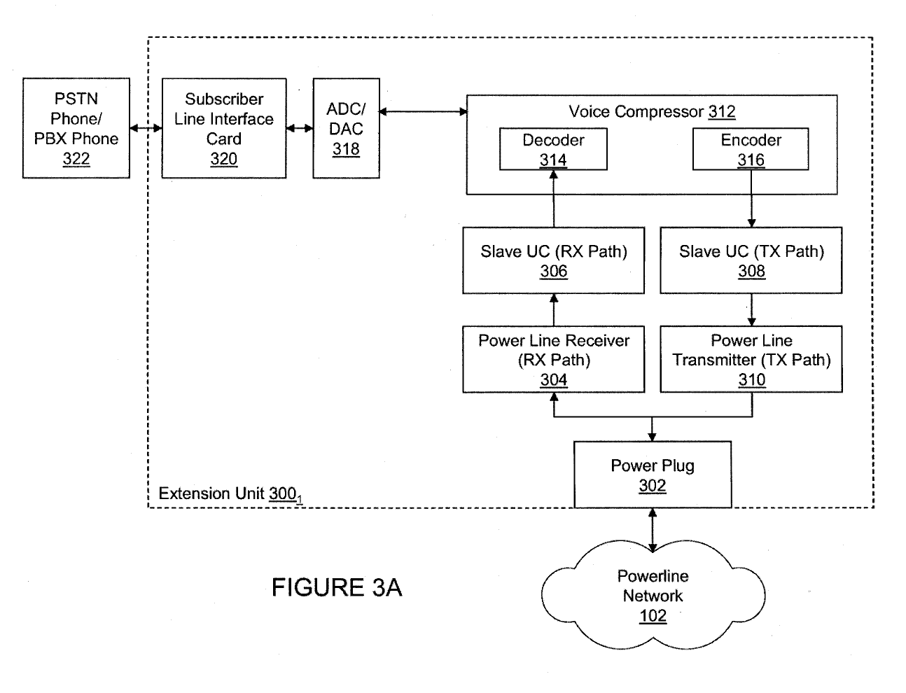

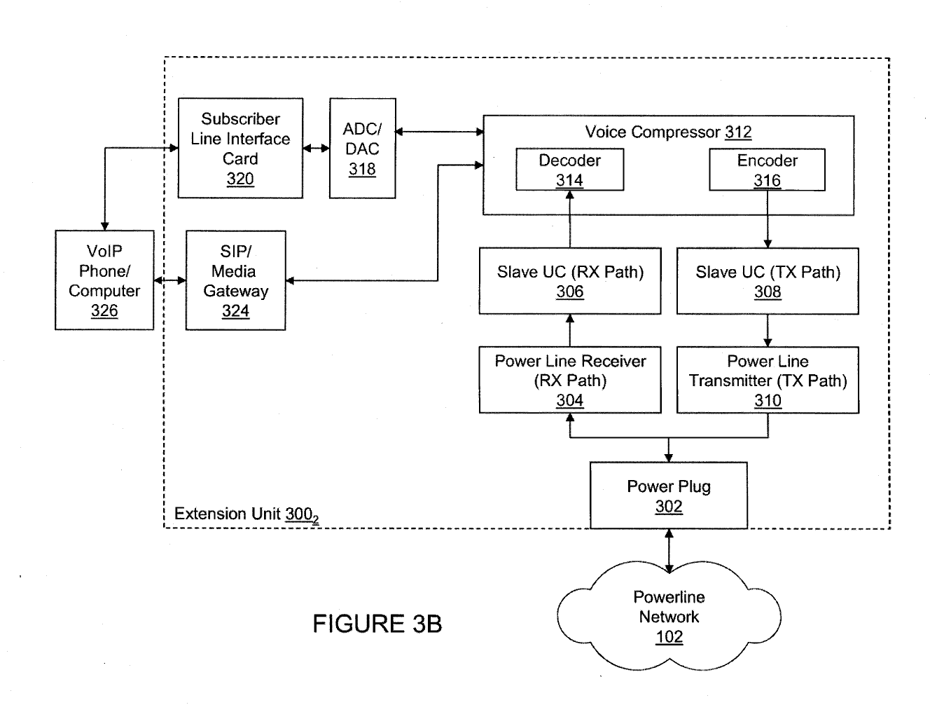

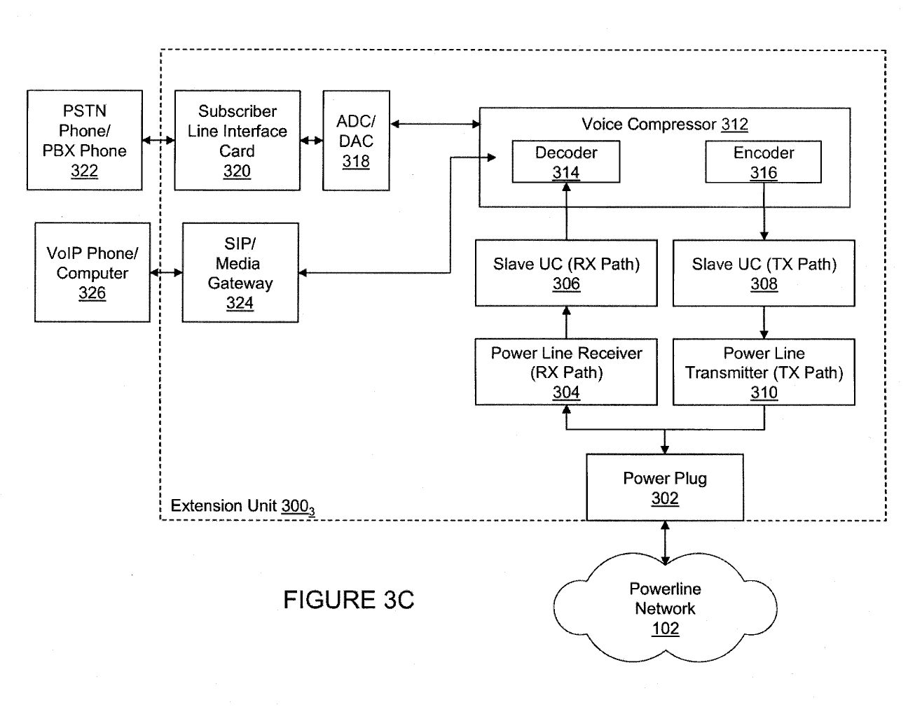

FIGS. 3A-3C are block diagrams of exemplary extension units in accordance with the present invention. Extension unit 300, can be used to support a PSTN telephone and/or PBX telephone 322 for communicating with powerline network 102. Extension unit 300₁ includes a power plug 302 that can be inserted into an electrical outlet to couple the unit to powerline network 102. Power plug 302 is coupled to a powerline receiver 304, which in turn is coupled to a slave unit controller 306. Slave unit controller 306 is coupled to decoder 314 of voice compressor 812. Power plug 302 is also coupled to powerline transmitter 310, which in turn is coupled to slave unit controller 308. Slave unit controller 308 is coupled to encoder 316 of voice compressor 312.

Powerline transmitter and receiver 304 and 310 can be separate components or can be integrated into a single transceiver, Regardless, the component will include the ability to support half-duplex frequency shift key (FSI) modulation, and include an integrated powerline driver with programmable voltage and current control. The transceivers can operate at programmable transmission frequencies and/or baud rates. The receiving sensitivity can be adjusted, and the transceiver also provides carrier or preamble detection. Any of the aforementioned functions can be adjusted using a programmable control register.

Voice compressor 312 is coupled to an analog-to-digital converter/digital-to-analog converter 318 (ADC/DAC), which in turn is coupled to a subscriber line interface card 320. ADC/DAC converts digital voice from compressor 312 into analog voice for subscriber line interface card 320 and vice versa. Subscriber line interface card 320 includes an input to accept a connection to PSTN telephone/PBX telephone 322 in order to couple the telephone to the central control unit.

The extension unit 302₂ of FIG. 3B is similar to that of extension unit 300₁ of FIG. 3A, except that extension unit 302₂ is used for coupling a VoIP telephone and/or computer 326 to powerline network 102. Extension unit 302₂ includes a session initiation protocol (SIP)/media gateway 324. When extension unit 302₂ is coupled to a computer, communications between slave unit controllers 306 and 308 and SIP/media gateway,324 need not pass through voice compressor 312. If the VoIP phone/computer 326 is compatible with analog signals., then extension unit 302₂ can also include an ADC/DAC 318 and subscriber line interface card 320.

Extension unit 300₃ of FIG. 3C includes the ability to couple both PSTN telephone/PBX telephone 322 and VoIP telephone/computer 326 to powerline network 102. This provides the added flexibility that extension unit 300₃ can be employed with any type of communication device.

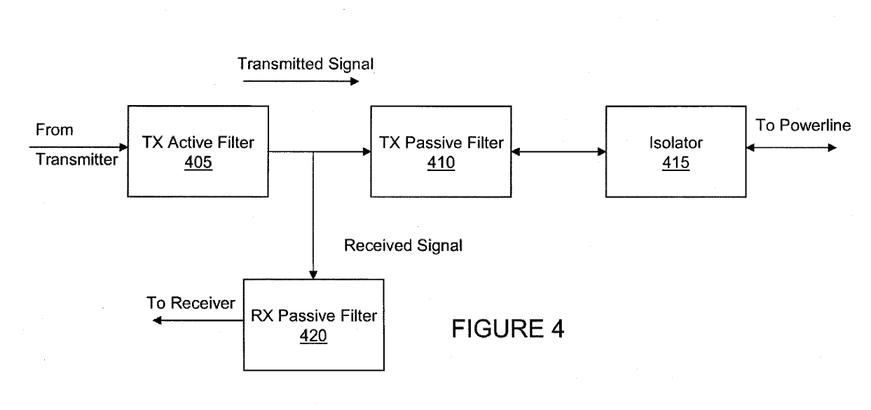

As discussed above., powerlines are particularly noisy. Accordingly, exemplary embodiments of the present invention can employ the filter of FIG. 4 between the powerline and the transmitter/receiver of the central control unit and the extension units. The filter includes a transmit active filter 405 that receives signals from the transmitter and passes the signals to a transmit passive filter 410. Transmit passive filter passes the signals to isolator 415, which in turn passes the signals to the powerline network. Isolator 415 can be, for example an optical isolator.

Communication signals received from the powerline network pass from isolator 415 to transmit passive filter 410, and then to receive passive filter 420. Receive passive filter 420 passes the filtered signals to the receiver of the central control unit or extension unit. The various filters can be arranged to filter out noise and can be tuned to particular frequencies and amplitudes in which the communication signals are carried. For example, the filters can be tuned to pass signals in the 1800 MHz and 2.4 GHz bands.

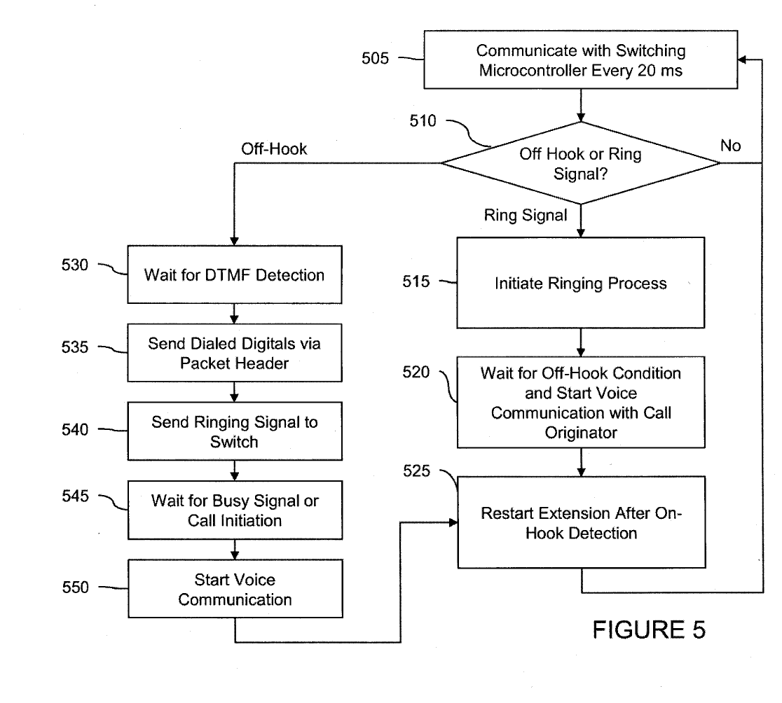

FIG. 5 is a flow diagram of an exemplary method in accordance with the present invention. Master microcontroller 214 communicates with switching microcontroller 212 every 20 milliseconds (step 505) in order to determine whether there is an off-hook or ring signal (step 510). When there is not an off-hook or ring signal (“No” path out of decision step 510), master microcontroller 214 waits another 20 milliseconds to communicate with switching microcontroller 212. When switching microcontroller 212 informs master microcontroller 214 of a ring signal (“Ring Signal”) path out of decision step 510) master microcontroller 214 initiates the ringing process (step 515). Specifically, master microcontroller checks the status of the destination extension unit (e.g., busy or available) and then sends a ringing signal to the destination extension unit.

Master microcontroller 214 waits for an off-hook condition and then starts the voice communication between the call originator and the call destination (step 520). When master microcontroller 214 detects an on-hook condition for the extension unit then master microcontroller resets the extension unit in database 216 (step 625), and then it continues to communicate with switching microcontroller 212 (step 505).

When switching microcontroller 212 informs master microcontroller 214 of an off-hook condition for a particular extension unit (“Off-Hook” path out of decision step 510), master microcontroller 214 updates the database of the off-hook status of the extension unit and waits for DTMF signals corresponding to a dialed telephone number (step 530). Master microcontroller 214 then sends the dialed digits in a packet header to the destination extension unit (step 535) and sends a ringing signal to switching microcontroller 212 (step 640). Master microcontroller 214 then waits for a busy signal or the initiation of the call (step 545) and in the case of a call initiation starts voice communications between the call originator and call destination (step 550). Upon detecting an on-hook condition: master microcontrouer 214 restarts the extensions (step 525) and continues to communicate with the switching microcontroller 212.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A system comprising:
a controller that includes
a plurality of transceivers, each of the plurality of transceivers are coupled to a powerline network; and
a switch coupled to each of the plurality of transceivers;
an extension unit that includes
a transceiver coupled to the powerline network; and
an interface to a communication unit,
wherein the controller is coupled to a broadband wireless network via the powerline network and the switch of the controller switches communications between the extension unit and the broadband wireless network.

2. The system of claim 1, wherein the controller and extension unit each include a voice compressor.

3. The system of claim 1, wherein the communication unit is a public switched network (PSTN) or private branch exchange (PBX) telephone and the extension unit further comprises:
a digital-to-analog/analog-to-digital converter coupled to the extension unit transceiver; and
a subscriber line interface coupled between the digital-to-analog/analog-to. digital converter and the PSTN or PBX telephone.

4. The system of claim 1, wherein the communication unit is a Voice over Internet Protocol (VoIP) telephone or a computer and the extension unit further comprises:
a session initiation protocol (SIP) and media gateway coupled between the extension unit transceiver and the VoIP telephone or computer.

5. The system of claim 1, wherein the extension unit further comprises:
a digital-to-analog/analog-to-digital converter coupled to the extension unit transceiver;
a subscriber line interface coupled to the digital-to-analog/analog-to-digital converter; and
a session initiation protocol (SIP) and media gateway coupled to the extension unit transceiver.

6. The system of claim 1, wherein the controller further comprises a plurality of unit controllers, each of the plurality of unit controllers are coupled between a respective one of the plurality of transceivers and the switch.

7. The system of claim 1, further comprising:
a broadband transceiver coupled between the controller and the broadband wireless network.

8. The system of claim 1, wherein the extension unit transceiver and the plurality of transceivers modulate communications onto a powerline of the powerline network.

9. The system of claim 8, wherein the communications are voice communications.

10. The system of claim 8, wherein the communications are data communications.

11. The system of claim 1, wherein the controller provides private branch exchange functions.

12. The system of claim 11, wherein the private branch exchange functions include switching incoming calls to the extension unit, establishing an intercom between the extension unit and another extension unit, placing a call on hold, transferring a call from the extension unit to another extension unit, forwarding a call from the extension unit to another extension unit.

13. A control unit comprising:
a plurality of transceivers, each of the plurality of transceivers are coupled to a powerline network; and
a switch coupled to each of the plurality of transceivers,
wherein the control unit is coupled to a broadband wireless network and an extension unit via the powerline network, and
wherein the switch of the control unit switches communications between the extension unit and the broadband wireless network.

14. The control unit of claim 13, wherein the control unit includes a voice compressor.

15. The control unit of claim 13, wherein the control unit provides private branch exchange functions.

16. The control unit of claim 15, wherein the private branch exchange functions include switching incoming calls to the extension unit, establishing an intercom between the extension unit and another extension unit, placing a call on hold, transferring a call from the extension unit to another extension unit, forwarding a call from the extension unit to another extension unit.

17. An extension unit comprising:
a transceiver coupled to the powerline network; and
an interface to a communication unit,
wherein the transceiver of the extension unit is coupled to a broadband wireless network and at least one other extension unit via the powerline network.

18. The extension unit of claim 17, wherein the communication unit is a public switched network (PSTN) or private branch exchange (PBX) telephone and the extension unit further comprises:
a digital-to-analog/analog-to-digital converter coupled to the extension unit transceiver; and
a subscriber line interface coupled between the digital-to-analog/analog-to-digital converter and the PSTN or PBX telephone.

19. The extension unit of claim 17, wherein the communication unit is a Voice over Internet Protocol (VoIP) telephone or a computer and the extension unit further comprises:
a session initiation protocol (SIP) and media gateway coupled between the extension unit transceiver and the VoIP telephone or computer.

20. The extension unit of claim 17, wherein the extension unit further comprising:
a digital-to-analog/analog-to-digital converter coupled to the extension unit transceiver;
a subscriber line interface coupled to the digital-to-analog/analog-to-digital converter; and
a session initiation protocol (SIP) and media gateway coupled to the extension unit transceiver.
